(19) United States
(12) Patent Application Publication
(10) Pub. No.: US 2008/0012468 A1
(43) Pub. Date: Jan. 17, 2008

(54) Light emission device and display device

(75) Inventors: Young-Suk Cho, Yongin-si (KR); Jae-Myung Kim, Yongin-si (KR); Yoon-Jin Kim, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/730,417

(22) Filed: Apr. 2, 2007

(30) Foreign Application Priority Data
Jul. 13, 2006 (KR) 10-2006-0065858
Aug. 3, 2006 (KR) 10-2006-0073391

(51) Int. Cl. H01J 63/04

(52) U.S. Cl. 313/496

(57) ABSTRACT

A light emission device and a display device having the light emission device as a light source are provided. The light emission device includes first and second substrates facing each other, an electron emission unit that is located on an inner surface of the first substrate and includes a plurality of electron emission elements, a phosphor layer located on an inner surface of the second substrate, and an anode electrode located on the phosphor layer. Each of the electron emission elements includes a plurality of first electrodes arranged in parallel with each other, a plurality of second electrodes arranged in parallel with each other between the first electrodes, and a plurality of electron emission regions that are electrically connected to the first electrodes.

### CROSS-REFERENCE TO RELATED APPLICATIONS

This application claims the benefit of Korean Applications Nos. 2006-65858 and 2006-73391, filed Jul. 13, 2006 and Aug. 3, 2006, respectively, in the Korean Intellectual Property Office, the disclosures of which are incorporated herein by reference.

### BACKGROUND OF THE INVENTION

1. Field of the Invention

Aspects of the present invention relate to a light emission device and a display device having the light emission device as a light source.

2. Description of the Related Art

A display device having a passive type display panel, such as a liquid crystal panel, requires a light source emitting light to the display panel. Generally, a cold cathode fluorescent lamp (CCFL) type light emission device and a light emitting diode (LED) type light emission device have been widely used as the light source of the display device.

Since a CCFL type light emission device and an LED type light emission device have, respectively, a line light source and a point light source, they have optical members for diffusing light. The optical members, however, may cause a light loss while the light passes through the optical members and thus a CCFL type light emission device and an LED type light emission device must be used with a relatively high voltage in order to obtain sufficient luminance. This makes it difficult to enlarge the display device.

Recently, a light emission device has been made available that incorporates a first substrate on an electron emission unit having electron emission regions and driving electrodes. A second substrate on which a phosphor layer and an anode electrode are formed has been proposed in place of the CCFL type light emission device and the LED type light emission device. This newer light emission device emits visible light by exciting the phosphor layer using electrons emitted from the electron emission regions.

When the light emission device is used as the light source of the display device, important optical properties are to (a) make it possible to realize a high luminance with relatively lower power consumption, (b) emit light with uniform intensity throughout an active area, and (c) improve the display quality (e.g., dynamic contrast) of an image realized by the display device.

### SUMMARY OF THE INVENTION

Exemplary embodiments in accordance with the present invention provide a light emission device that is designed to realize a high luminance with low power consumption and improve not only luminance uniformity but also a dynamic contrast of an image realized by a display device, as well as a display device using the light emission device as a light source.

In an exemplary embodiment of the present invention, a light emission device includes first and second substrates facing each other, an electron emission unit that is located on the inner surface of the first substrate and includes a plurality of electron emission elements, a phosphor layer located on the inner surface of the second substrate, and an anode electrode located on the phosphor layer. Each of the electron emission elements includes a plurality of first electrodes arranged in parallel with each other, a plurality of second electrodes arranged in parallel with each other between the first electrodes, and a plurality of first electron emission regions that are electrically connected to the first electrodes.

The light emission device may further include a plurality of second electron emission regions that are electrically connected to the second electrodes. The first electron emission regions may be located on side surfaces of the first electrodes and extend in the length direction of each of the first electrodes, and the second electron emission regions may be located on side surfaces of the second electrode and extend in the length direction of each of the second electrodes. The first and second electrodes may function alternately as cathode and gate electrodes.

Each of the electron emission elements may further include a first connecting portion interconnecting first ends of the first electrodes, and a second connecting portion interconnecting second ends of the second electrodes. The electron emission unit may include a plurality of first conductive lines extending from the first connecting portions of the electron emission elements to an edge of the first substrate, and a plurality of second conductive lines extending from the second connecting portions of the electron emission elements to the edge of the first substrate.

The first conductive lines may extend to a first edge of the first substrate along a first direction of the first substrate, and the second conductive lines may extend to a second edge of the first substrate along the first direction. The first and second edges may be opposite to each other.

An insulation layer may be located between the first substrate and the electron emission elements while covering the first and second conductive lines. The insulation layer may be provided with via-holes for partly exposing the first and second lines of each electron emission elements. The via-holes may be filled with a conductive layer to electrically connect the first and second conductive lines to the first and second connecting portions, respectively.

The first conductive lines may be connected to the first connecting portions that are arranged along the first direction of the first substrate, and the second conductive lines may be connected to the second connecting portions that are arranged along a direction intersecting the first direction. An isolation layer may be located between the first and second conductive lines in a region where the first and second lines intersect each other.

The first electrodes are spaced apart from the first connecting portion and resistive layers may be located between each of the first electrodes and the first connecting portion. The second electrodes are spaced apart from the second connecting portion and resistive layers may be located between each of the second electrodes and the second connecting portion.

In another exemplary embodiment, a display device includes a display panel to display an image, and a light emission device to emit light toward the display panel, wherein the light emission device includes first and second substrates facing each other; an electron emission unit that is located on an inner surface of the first substrate and includes a plurality of electron emission elements; a phosphor layer located on an inner surface of the second substrate; and an anode electrode located on the phosphor layer. Each of the electron emission elements includes a plurality of first electrodes arranged in parallel with each other; a plurality of second electrodes arranged in parallel with each other between the first electrodes; and a plurality of first electron emission regions that are electrically connected to the first electrodes.

When the display panel includes first pixels, the light emission device includes second pixels, the number of second pixels is less than that of the first pixels and the light emission intensity of each second pixel may be independently controlled.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a partially cut-away perspective view of a light emission device according to a first exemplary embodiment of the present invention;

FIG. 2 is a perspective view of an electron emission element of the light emission device according to the first exemplary embodiment of the present invention;

FIG. 3 is a partial sectional view of the light emission device according to the first exemplary embodiment of the present invention;

FIG. 4 is a top plane view of an electron emission element of a light emission device according to a second exemplary embodiment of the present invention;

FIG. 5 is a partial sectional view of the light emission device according to the second exemplary embodiment of the present invention;

FIG. 6 is a partial top plane view of an electron emission unit of a light emission device according to a third exemplary embodiment of the present invention;

FIG. 7 is a sectional view taken along line I-I of FIG. 6;

FIG. 8 is a partial top plane view of an electron emission unit of a light emission device according to a fourth exemplary embodiment of the present invention;

FIG. 9 is a sectional view taken along line II-II of FIG. 8;

FIG. 10 is a partial top plane view of an electron emission element of a light emission device according to a fifth exemplary embodiment of the present invention;

FIG. 11 is a partial top plane view of a modified example of the electron emission element of the light emission device according to the fifth embodiment of the present invention;

FIG. 12 is a partial top plane view of an electron emission element of a light emission device according to a sixth exemplary embodiment of the present invention;

FIG. 13 is a partial top plane view of a modified example of the electron emission element of the light emission device according to the sixth embodiment of the present invention; and

FIG. 14 is an exploded perspective view of a display device according to an exemplary embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

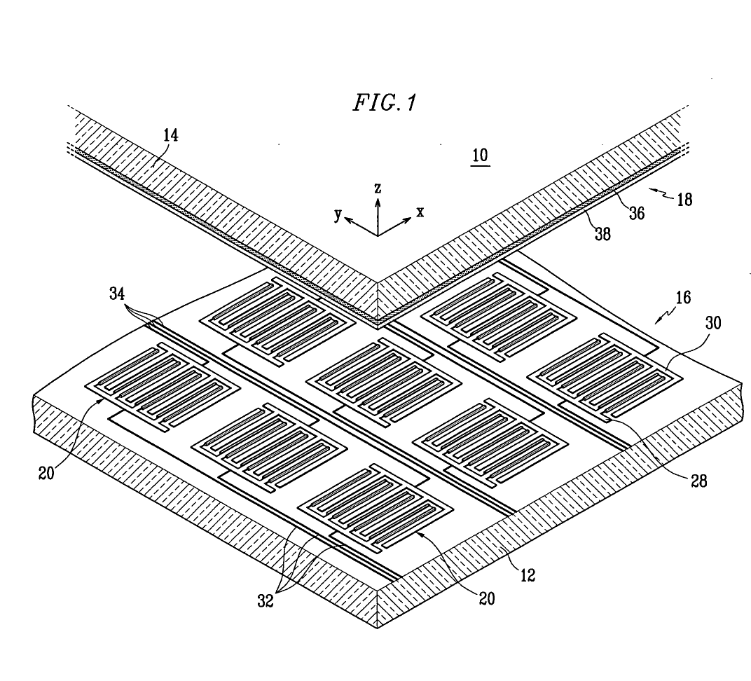

FIG. 1 is a partially cut-away perspective view of a light emission device according to a first exemplary embodiment of the present invention.

Referring to FIG. 1, a light emission device 10 includes first and second substrates 12 and 14 facing each other in a parallel manner at a predetermined interval. A sealing member (not shown) is provided between peripheries of the first and second substrates 12 and 14 to seal them together and thus form a vacuum vessel. The interior of the vacuum vessel is kept to a degree of vacuum of about 10⁻⁶ Torr.

An electron emission unit 16 for emitting electrons toward the second substrate 14 is located on an inner surface of the first substrate 12 and a light emission unit 18 for emitting visible light by utilizing the electrons is located on an inner surface of the second substrate 14. The first substrate 12 may be the rear substrate of the light emission device 10 and the second substrate 14 may be the front substrate of the light emission device 10.

In this first exemplary embodiment, the electron emission unit 16 includes a plurality of electron emission elements 20 that are independently controlled in their electron emission amount.

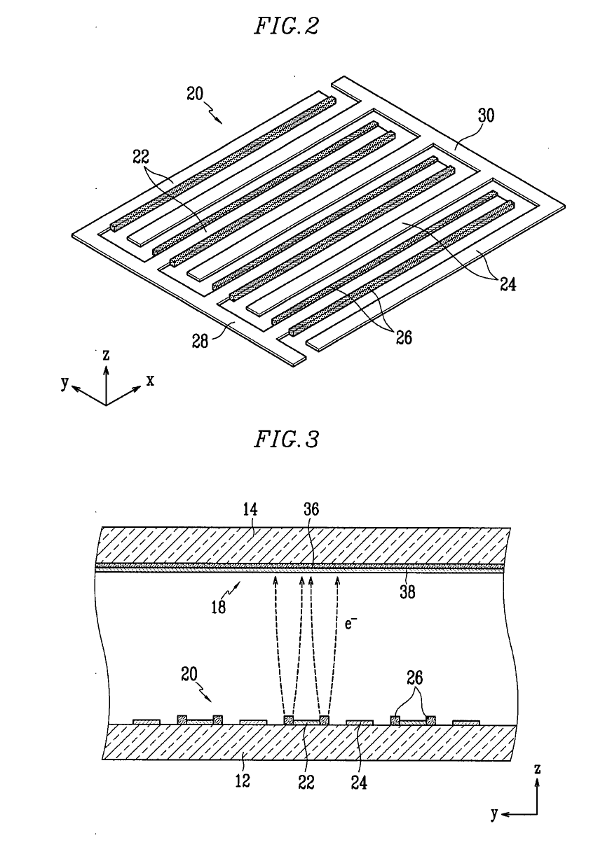

FIG. 2 is a perspective view of an electron emission element of the light emission device of FIG. 1, and FIG. 3 is a partial sectional view of the light emission device, both according to the first exemplary embodiment of the present invention.

Referring to FIGS. 2 and 3, each of the electron emission elements 20 includes a plurality of first electrodes 22 that are arranged in a linear and parallel pattern extending in a first direction (an x-axis in FIG. 2) of the first substrate 12, a plurality of second electrodes 24 that are arranged in parallel with and between the first electrodes 22 on the first substrate 12, and electron emission regions 26 that are electrically connected to the first electrodes 22.

The first electrodes 22 function as cathode electrodes that can apply a current to the electron emission regions 26 and the second electrodes 24 function as gate electrodes for inducing the electron emission by forming an electric field using a voltage difference between the gate and cathode electrodes.

The first electrodes 22 and the second electrodes 24 are alternately arranged. Distal ends of the first electrodes 22 are connected to a connecting portion 28 to be applied with a driving voltage through the connecting portion 28. Distal ends of the second electrodes 24 are also connected to a connecting portion 30 to be applied with a driving voltage through the connecting portion 30. In the drawing of FIG. 2, the first connecting portion 28 is located on and electrically connected to the left ends of the first electrodes 22 and the second connecting portion 30 is located on and connected to the right ends of the second electrodes 24.

The first and second electrodes 22 and 24 may be transparent electrodes formed by a transparent material such as indium tin oxide (ITO). Alternatively, each of the first and second electrodes 22 and 24 includes a transparent electrode and a metallic sub-electrode formed on the transparent electrode. In both of these cases, since the first and second electrodes 22 and 24 are arranged in a parallel manner on the first substrate 12, the first and second electrodes 22 and 24 can be constructed in like patterns, thereby simplifying the manufacturing process of the light emission device.

The electron emission regions 26 are located on opposite side surfaces of each of the first electrodes 22 while extending in the length direction of the first electrodes 22. At this point, the electron emission regions 26 are spaced apart from the second electrodes 24 by a predetermined distance. The electron emission regions 26 may contact only the side surfaces of the first electrodes 22 or contact the side surfaces and portions of the top surfaces of the first electrodes 22. In the drawing, the first case is illustrated.

The electron emission regions 26 are made from a material that emits electrons when an electric field is formed around the electron emission regions in a vacuum atmosphere. The electron emission regions 26 are made from materials such as a carbon-based material or a nanometer-sized material, for example a material selected from the group consisting of carbon nanotubes, graphite, graphite nanofibers, diamonds, diamond-like carbon, fullerene (C₆₀), silicon nanowires, and a combination thereof. As to a method for forming the electron emission regions 26, a screen-printing process, a direct growth process, a chemical vapor deposition process or a sputtering method may be used.

Referring again to FIG. 1, the above-described electron emission elements 20 are arranged in a parallel manner on the first substrate 12 and spaced apart from each other at predetermined intervals. Conductive lines 32 and 34 for applying the driving voltages to the first and second connecting portions 28 and 30 connect the electron emission elements 20.

Each of the electron emission elements 20 includes a first conductive line 32 extending from the first connecting portion 28 to an edge of the first substrate 12, and a second conductive line 34 extending from the second connecting portion 30 to the edge of the first substrate 12. The first and second conductive lines 32 and 34 are arranged in a parallel manner but extend toward opposite edges of the first substrate 12 along the y-axis of FIG. 1. The first and second conductive lines 32 and 34 are electrically connected to respective driving circuit units (not shown) at the edges of the first substrate 12.

Referring to FIGS. 1 and 3, the light emission unit 18 includes a phosphor layer 36 and an anode electrode 38 located on the phosphor layer 36. The phosphor layer 36 may be formed of a mixture of red, green and blue phosphors to emit white light. The phosphor layer 36 may be formed on the entire active area of the second substrate 14.

The anode electrode 38 may be formed of a metal layer such as an aluminum (Al) layer. The anode electrode 38 is an acceleration electrode that attracts electrons emitted from the electron emission regions 26 toward the phosphor layer 36. The anode electrode 38 functions to enhance the screen luminance by reflecting the visible light, which is emitted from the phosphor layer 36 to the first substrate 12, toward the second substrate 14.

Disposed between the first and second substrates 12 and 14 are spacers (not shown) that are able to withstand the compression force on the vacuum vessel and to uniformly maintain a gap between the first and second substrates 12 and 14.

The light emission device 10 is driven by applying predetermined voltages to the first and second electrodes 22 and 24 and the anode electrode 38. That is, the anode electrode 38 is applied with a positive direct current (DC) voltage (anode voltage) of thousands of volts or more, and the first and second electrodes 22 and 24 are selectively applied with a predetermined driving voltage, thereby independently controlling an electron emission amount of the electron emission elements 20.

For example, for one electron emission element 20, when different voltages are respectively applied to the first and second electrodes 22 and 24, electric fields are formed around the electron emission regions 26 by the voltage difference between the first and second electrodes 22 and 24, and thus electrons (e⁻ in FIG. 3) are emitted from the electron emission regions 26. The emitted electrons collide with a corresponding portion of the phosphor layer 36 by being attracted by the anode voltage, thereby exciting the phosphor layer 36.

During the above-described process, the cathode voltage applied to the first electrodes 22 may be 0V or several through tens of volts, while the gate voltage applied to the second electrodes 24 may be several through tens of volts, and is greater than the cathode voltage. For simplicity, in the example of FIG. 3, where the electrons are being shown as emitted from one of the electron emission regions 26, the electrons are actually and simultaneously emitted from all of the electron emission regions 26 of the single electron emission elements 20.

As described above, the light emission device 10 of this first exemplary embodiment divides the light emission surface into a plurality of sections (the number of the electron emission elements 20 in the above-described structure and driving method), and each element can emit a different intensity of visible light. Therefore, the light emission device 10 can contribute toward increasing the dynamic contrast of an image realized by a display panel when the light emission device is used as a light source for a display device that will be described later.

In addition, the above-described light emission device 10 can reach a luminance of 10,000 cd/m² at a central portion of the light emission surface. That is, the light emission device 10 can reach a higher luminance with a lower electric power consumption compared with a conventional cold cathode fluorescent lamp (CCFL) type light emission device and a conventional light emitting diode (LED) type light emission device.

The following will describe light emission devices according to second through sixth exemplary embodiments of the present invention. In the following description, like reference symbols indicate like components.

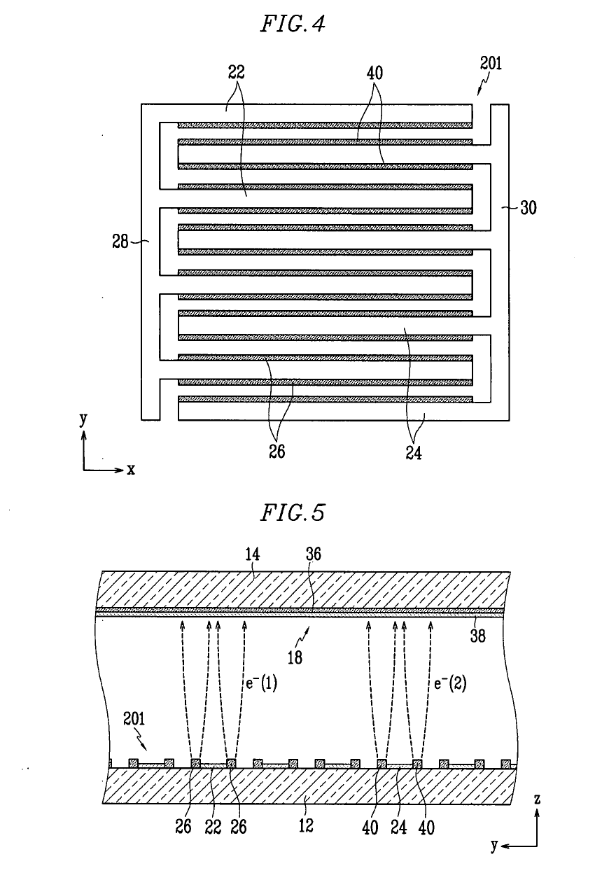

FIG. 4 is a top plane view of an electron emission element of a light emission device according to a second exemplary embodiment of the present invention, and FIG. 5 is a partial sectional view of the light emission device according to the second exemplary embodiment of the present invention.

Referring to FIGS. 4 and 5, an electron emission element 201 includes a plurality of first electrodes 22 that are arranged in a linear and parallel pattern extending in a first direction (the x-axis in FIG. 4) of the first substrate 12, a plurality of second electrodes 24 that are arranged in parallel with and between the first electrodes 22 on the first substrate 12, first electron emission regions 26 electrically connected to the first electrodes 22, and second electron emission regions 40 that are electrically connected to the second electrodes 24.

The first electrodes 22 are connected to a first connecting portion 28 and the second electrodes 24 are connected to a second connecting portion 30. The second electron emission regions 40 are located on opposite side surfaces of each of the second electrodes 24 while extending in the length direction of the second electrode 24. In order to prevent short circuits with the first electrodes 22, the second electron emission regions 40 are spaced apart from the first electron emission regions 26.

The first and second electrodes 22 and 24 function as cathode or gate electrodes depending on the voltage applied thereto. A driving method where cathode and gate voltages are alternately and repeatedly applied to the first and second electrodes 22 and 24 may be used.

That is, in a time interval t1, the first electrodes 22 are applied with the cathode voltage and the second electrodes 24 are applied with the gate voltage. Subsequently, in a time interval t2, the first electrodes 22 are applied with the gate voltage and the second electrodes 24 are applied with the cathode voltage. Then, in the time interval t1, the first electron emission regions 26 emit electrons (e⁻(1) in FIG. 5) to excite the phosphor layer 36. In the time interval t2, the second electron emission regions 40 emit electrons (e⁻(2) in FIG. 5) to excite the phosphor layer 36.

The times intervals t1 and t2 may alternately repeat so that the first and second electron emission regions 26 and 40 alternately emit the electrons. In this driving method, the load applied to the first electron emission regions 26 is reduced and thus the service life of the electron emission regions 26 and 40 can be improved.

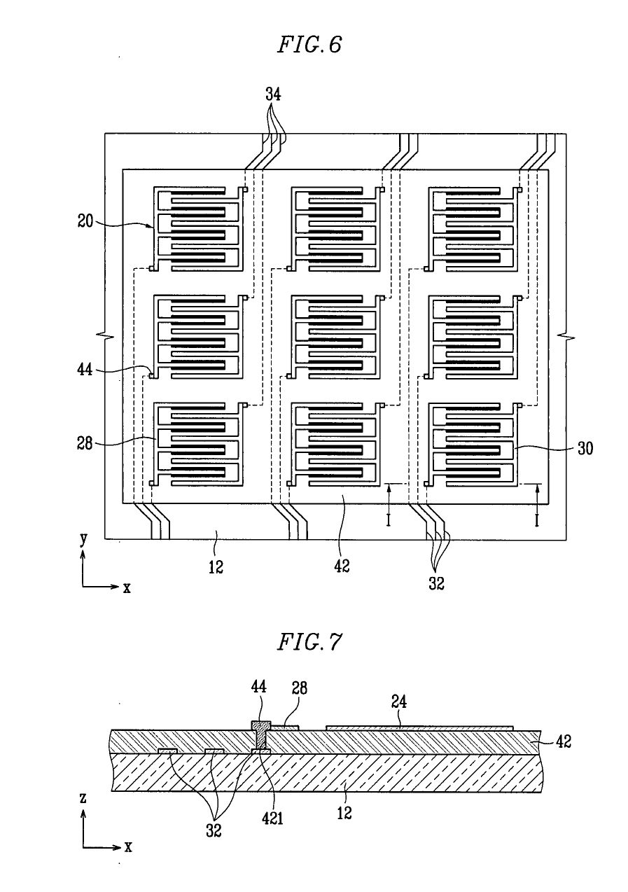

FIG. 6 is a partial top plane view of an electron emission unit of a light emission device according to a third exemplary embodiment of the present invention and FIG. 7 is a sectional view taken along line I-I of FIG. 6.

Referring to FIGS. 6 and 7, in a light emission device according to a third embodiment of the present invention, an insulation layer 42 is located between the first substrate 12 and electron emission elements 20. The insulation layer 42 covers the first and second conductive lines 32 and 34 formed on the first substrate 12 to prevent the first and second conductive lines 32 and 34 from being exposed toward the second substrate 14.

The insulation layer 42 is provided with via-holes 421, each of which is formed near a first connecting portion 28 at each electron emission elements 20 to partly expose the first conductive line 32. Each of the via-holes 421 is filled with a conductive layer 44 contacting the first connecting portion 28, thereby electrically connecting the first conductive line 32 to the first connecting portion 28. Likewise, each of the second connecting portions 30 is electrically connected to the second conductive line 34 through the via-hole 421 and the conductive layer 44.

In the above-described structure, since the first and second conductive lines 32 and 34 are covered with the insulation layer 42 and thus are not affected by succeeding processes, the damage of the first and second conductive lines 32 and 34 can be minimized in the succeeding processes. The electron emission elements 20 of the light emission device of this third exemplary embodiment are identically structured those of the first and second exemplary embodiments. In FIG. 6, the electron emission elements 20 of the first exemplary embodiment are illustrated as an example.

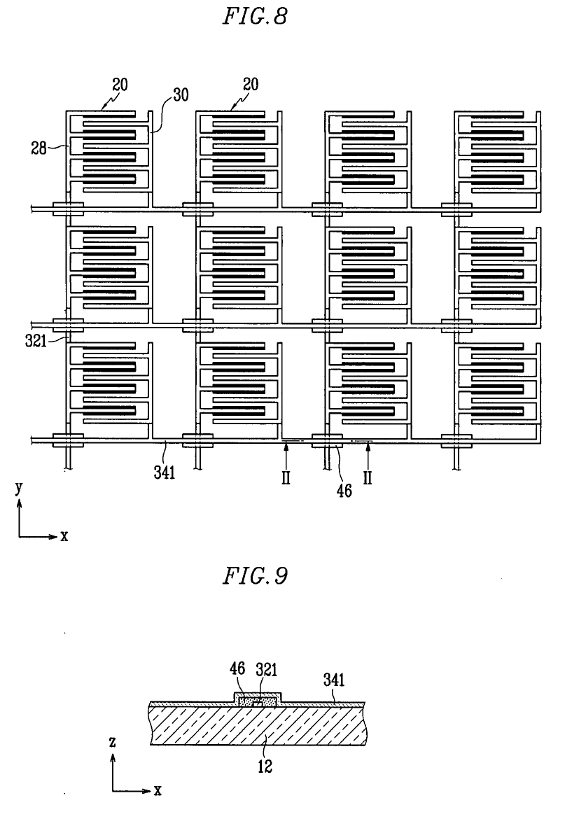

FIG. 8 is a partial top plane view of an electron emission unit of a light emission device according to a fourth exemplary embodiment of the present invention and FIG. 9 is a sectional view taken along line II-II of FIG. 8.

Referring to FIGS. 8 and 9, in a light emission device of the fourth exemplary embodiment of the present invention, the first and second conductive lines 321 and 341 extend in directions that intersect each other at a right angle.

That is, the first conductive lines 321 extend in a first direction (the y-axis in FIG. 8) of the first substrate 12 and are connected to the first connecting portions 28 of the electron emission elements 20 that are arranged along the first direction. The second conductive lines 341 extend in a second direction (the x-axis in FIG. 8) crossing the first direction at a right angle and are connected to second connecting portions 30 of the electron emission elements 20 that are arranged along the second direction.

Isolation layers 46 are located between the first and second conductive lines 321 and 341 at regions where the first conductive lines 321 intersect the second conductive lines 341. The width of each of the isolation layers 46 is greater than those of the corresponding first and second conductive lines 321 and 341 to prevent any short circuit between the first and second conductive lines 321 and 341. In FIGS. 8 and 9, an example is illustrated where the first conductive lines 321, the isolation layers 46, and the second conductive lines 341 are located in this respective order on the first substrate 12. The order of the first and second conductive lines 321 and 341 on the first substrate 12, however, may be reversed.

In the above-described structure of FIGS. 8 and 9, the first and second conductive lines 321 and 341 are not provided for each of the respective electron emission elements 20 but are provided as common lines for each of rows and columns along which the electron emission elements 20 are arranged. Therefore, the inactive area between the electron emission elements 20 can be reduced and the arrangement of the first and second conductive lines 321 and 341 can be simplified.

The electron emission elements 20 of the light emission device of this fourth exemplary embodiment are structured to be identical to those of the first or second exemplary embodiments. In FIG. 8, the electron emission elements 20 of the first exemplary embodiment are illustrated as an example.

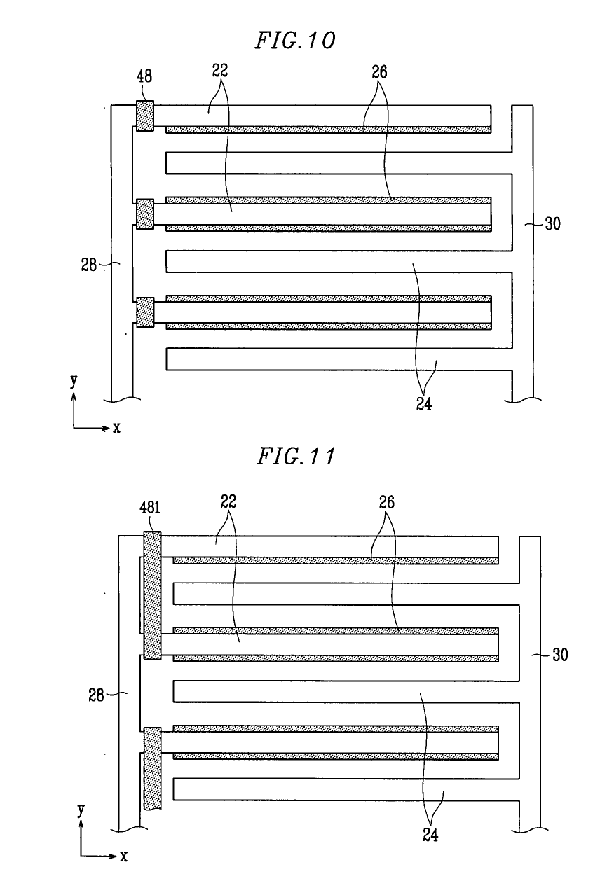

FIG. 10 is a partial top plane view of an electron emission element of a light emission device according to a fifth exemplary embodiment of the present invention.

Referring to FIG. 10, a light emission device of this fifth exemplary embodiment is basically identical to that of the first exemplary embodiment except that it further includes resistive layers 48 so that a uniform current is distributed to the first electrodes 22.

That is, the first connecting portion 28 is spaced apart from first electrodes 22 and the resistive layers 48 are located between the first connecting portion 28 and each of the first electrodes 22 to electrically connect the first connecting portion 28 to the first electrodes 22. The resistive layers 48 may be located at the respective first electrodes 22. In this case, the currents applied to the respective first electrodes 22 can be uniformly controlled. The resistive layers 48 may be formed of amorphous silicon doped with n-type or p-type ions. Each of the resistive layers 48 may have a specific resistance ranging from 10⁸ Ωcm to 10¹⁰ Ωcm.

According to the light emission device of the present exemplary embodiment, even if there is a resistance difference among the first electrodes 22, any phenomenon where the current is concentrated on a specific first electrode 22 can be suppressed. As a result, any short circuit of the first electrodes 22 can be prevented. Furthermore, discharge current amounts of the electron emission regions 26 can be uniformly controlled and thus the light emission uniformity can be enhanced.

FIG. 11 is a partial top plan view of a modified example of the electron emission element of the light emission device according to the fifth embodiment of the present invention.

Referring to FIG. 11, in this modified example, each resistive layer 481 is located over two or more of the first electrodes 22 to apply a uniform current to the first electrodes 22 connected to each of the resistive layers 481. In this configuration, there is no need to precisely pattern the resistive layers 481 for the respective first electrodes 22, the process margin can be improved and any connection error between the first connecting portion 28 and the first electrodes 22, which may be caused by an alignment error, can be minimized.

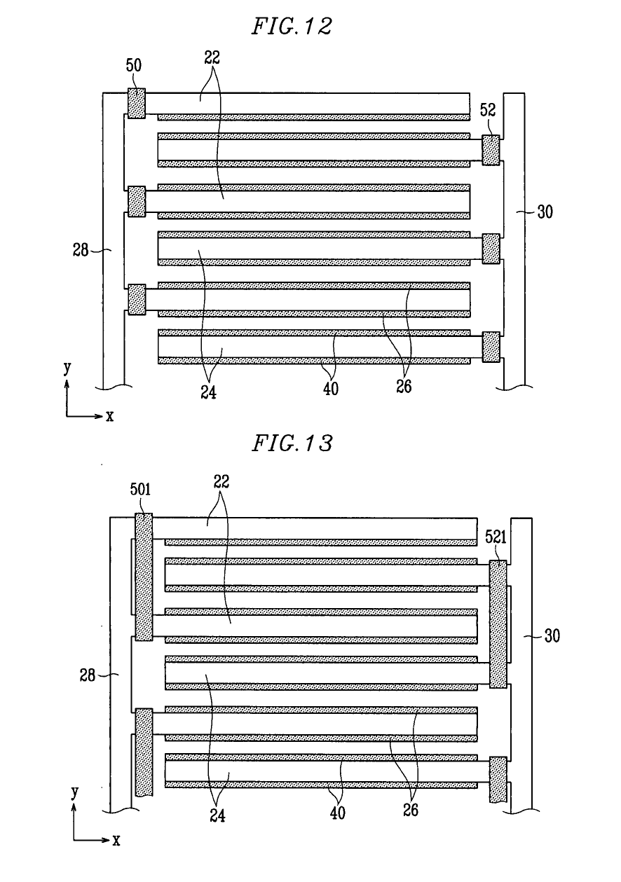

FIG. 12 is a partial top plan view of an electron emission element of a light emission device according to a sixth exemplary embodiment of the present invention.

Referring to FIG. 12, a light emission device of this sixth exemplary embodiment is basically identical to that of the second exemplary embodiment except that it further includes first resistive layers 50 for uniformly distributing a current to first electrodes 22 and second resistive layers 52 for uniformly distributing a current to second electrodes 24.

That is, the first connecting portion 28 is spaced apart from the first electrodes 22 and the first resistive layers 50 are located between the first connecting portion 28 and each of the first electrodes 22 to electrically connect the first connecting portion 28 to the first electrodes 22. The second connecting portion 30 is also spaced apart from the second electrodes 24 and the second resistive layers 52 are located between the second connecting portion 30 and each of the second electrodes 24 to electrically connect the second connecting portion 30 to the second electrodes 24.

The first resistive layers 50 may be located at the respective first electrodes 22. The second resistive layers 52 may be located at the respective second electrodes 24. In this case, the currents applied to the respective first electrodes 22 and the respective second electrodes 24 can be uniformly controlled. The first and second resistive layers 50 and 52 may be formed of amorphous silicon doped with n-type or p-type ions. Each of the first and second resistive layers 50 and 52 may have a specific resistance ranging from 10⁸ Ωcm to 10¹⁰ Ωcm.

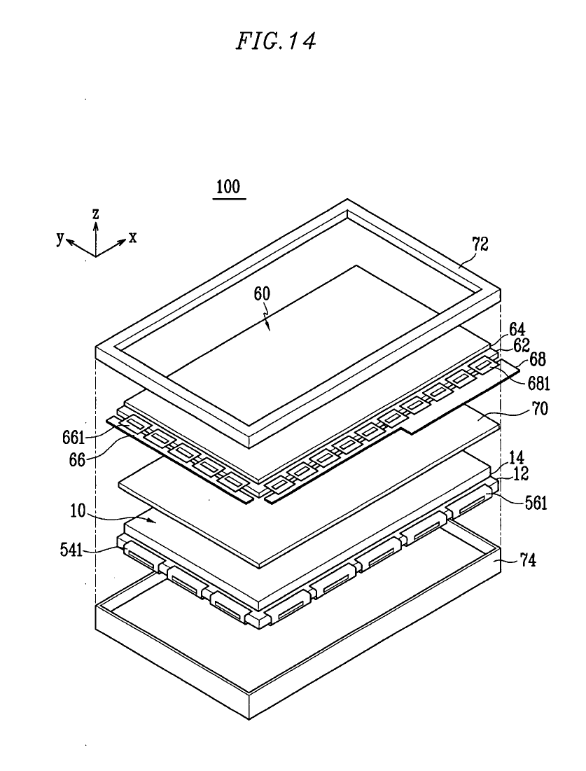

FIG. 13 is a partial top plane view of a modified example of the electron emission element of the light emission device according to the sixth embodiment of the present invention.

Referring to FIG. 13, in this modified example, each first resistive layer 501 is located over two or more of the first electrodes 22 and each second resistive layer 521 is located over two or more of the second electrodes 24. In this configuration, there is no need to precisely pattern the first and second resistive layers 501 and 521 for the respective first electrodes 22 and the respective second electrodes 24, the process margin can be improved and the connection error between the first connecting portion 28 and each of the first electrodes 22 and between the second connection portion 30 and each of the second electrodes 24, which may be caused by an alignment error, can be minimized.

FIG. 14 is an exploded perspective view of a display device using the above described light emission device as a light source according to an exemplary embodiment of the present invention. A display device illustrated in FIG. 14 is provided as only an example, not limiting the present invention.

Referring to FIG. 14, a display device 100 includes a light emission device 10 and a display panel 60 located in front of the light emission device 10. A diffuser plate 70 for uniformly diffusing light emitted from the light emission device 10 to the display panel 60 may be located between the light emission device 10 and the display panel 60. The diffuser plate 70 is spaced apart from the light emission device 10 by a predetermined distance.

A top frame 72 is located in front of the display panel 60 and a bottom frame 74 is located in the rear of the light emission device 10. A liquid crystal panel or other passive type (non-emissive type) display panels may be used as the display panel 60. In the following description, an example where the display panel 60 is a liquid crystal panel will be explained.

The display panel 60 includes a thin film transistor (TFT) panel 62 having a plurality of TFTs, a color filter panel 64 located above the TFT panel 62, and a liquid crystal layer (not shown) formed between the panels 62 and 64. Polarizing plates (not shown) are attached on the top surface of the color filter panel 64 and the bottom surface of the TFT panel 62 to polarize the light passing through the display panel 60.

Each of the TFTs has a source terminal connected to data lines, a gate terminal connected to gate lines, and a drain terminal connected to a pixel electrode formed of a transparent conductive material. When an electric signal is input from circuit board units 66 and 68 to the respective gate and data lines, the electric signal is input to the gate and source terminals of the TFT and the TFT is turned on or off in accordance with the electric signal to output an electric signal required for driving the pixel electrodes to the drain terminal.

The color filter panel 64 is a panel on which RGB color filters for emitting colors when the light passes through are formed. A common electrode formed of a transparent conductive material is formed on an entire surface of the color filter panel 64. When the TFT is turned on, an electric field is formed between the pixel electrode and the common electrode. A twisting angle of liquid crystal molecules is varied, in accordance of which the light transmittance of the corresponding pixel is varied.

The circuit board units 66 and 68 of the display panel 60 are respectively connected to driving IC packages 661 and 681. In order to drive the display panel 60, the gate circuit board unit 66 transmits a gate driving signal and the data circuit board unit 68 transmits a data driving signal.

The light emission device 10 includes a plurality of pixels, the number of which is less than the number of pixels of the display panel 60 so that one pixel of the light emission device 10 corresponds to two or more of the pixels of the display panel 60. Each pixel of the light emission device 10 emits the light in response to a highest gray level among gray levels of the corresponding pixels of the display panel 60. The light emission device 10 can represent a 2-8 bit gray at each pixel.

For convenience, the pixels of the display panel 60 will be referred to as first pixels and the pixels of the light emission device 10 will be referred to as second pixels. The first pixels corresponding to one second pixel is referred to as a first pixel group.

Describing a driving process of the light emission device 10, a signal control unit (not shown) controlling the display panel 60 detects the highest gray level of the first pixel group, operates a gray level required for emitting light from the second pixel in response to the detected high gray level, converts the operated gray level into digital data, and generates a driving signal of the light emission device 10 using the digital data.

The driving signal of the light emission device 10 may include a scan driving signal and a data driving signal. In this case, the light emission device 10 includes scan and data circuit board units (not shown) that are respectively connected to driving IC packages 541 and 561. In order to drive the light emission device 10, the scan circuit board unit transmits the scan driving signal and the data circuit board unit transmits the data driving signal.

When an image is displayed on the first pixel group, the corresponding second pixel of the light emission device 10 emits light with a predetermined gray level by synchronizing with the first pixel group. As described above, the light emission device 10 controls independently the light emission intensity of each pixel and thus provides the proper intensity of light to the corresponding pixels of the display panel 60. As a result, the display device 100 of the present exemplary embodiment can enhance the dynamic contrast of the screen, thereby improving the display quality.

Although exemplary embodiments of the present invention have been described in detail above, it should be clearly understood that many variations and/or modifications of the basic inventive concept taught herein still fall within the spirit and scope of the present invention, as defined by the appended claims and their equivalents.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A light emission device comprising:
first and second substrates facing each other;
an electron emission unit that is located on an inner surface of the first substrate and includes a plurality of electron emission elements;
a phosphor layer located on an inner surface of the second substrate; and
an anode electrode located on the phosphor layer,
wherein each of the electron emission elements comprises:
a plurality of first electrodes arranged in parallel with each other,
a plurality of second electrodes arranged in parallel with each other between the first electrodes, and
a plurality of first electron emission regions that are electrically connected to the first electrodes.

2. The light emission device of claim 1, further comprising a plurality of second electron emission regions that are electrically connected to the second electrodes.

3. The light emission device of claim 2, wherein the first electron emission regions are located on side surfaces of the first electrodes and extend in the length direction of each of the first electrodes; and
the second electron emission regions are located on side surfaces of the second electrode and extend in the length direction of each of the second electrodes.

4. The light emission device of claim 2, wherein the first and second electrodes function alternately as cathode and gate electrodes.

5. The light emission device of claim 1, wherein each of the electron emission elements further comprises:
a first connecting portion interconnecting first ends of the first electrodes; and
a second connecting portion interconnecting second ends of the second electrodes.

6. The light emission device of claim 5, wherein the electron emission unit further comprises:
a plurality of first conductive lines extending from the first connecting portions of the electron emission elements to an edge of the first substrate; and
a plurality of second conductive lines extending from the second connecting portions of the electron emission elements to the edge of the first substrate.

7. The light emission device of claim 6, wherein the first conductive lines extend to a first edge of the first substrate along a first direction of the first substrate; and
the second conductive lines extend to a second edge of the first substrate along the first direction, the first and second edges being opposite to each other.

8. The light emission device of claim 7, further comprising an insulation layer located between the first substrate and the electron emission elements while covering the first and second conductive lines, wherein the insulation layer is provided with via-holes for partly exposing the first and second conductive lines of each electron emission element, and the via-holes are filled with a conductive layer to electrically connect the first and second conductive lines to the first and second connecting portions, respectively.

9. The light emission device of claim 6, wherein the first conductive lines are connected to the first connecting portions that are arranged along the first direction of the first substrate;
the second conductive lines are connected to the second connecting potions that are arranged along a direction intersecting the first direction; and
an isolation layer is located between the first and second conductive lines at regions where the first and second conductive lines intersect each other.

10. The light emission device of claim 5, further comprising first resistive layers between each of the first electrodes and the first connecting portion, wherein the first electrodes are spaced apart from the first connecting portion.

11. The light emission device of claim 10, further comprising:
a plurality of second electron emission regions that are electrically connected to the second electrodes; and,
second resistive layers are located between each of the second electrodes and the second connecting portion, wherein the second electrodes are spaced apart from the second connecting portion.

12. A display device comprising:
a display panel for displaying an image; and
a light emission device for emitting light toward the display panel,
wherein the light emission device comprises first and second substrates facing each other; an electron emission unit that is located on an inner surface of the first substrate and includes a plurality of electron emission elements; a phosphor layer located on an inner surface of the second substrate; and an anode electrode located on the phosphor layer; and
each of the electron emission elements comprises a plurality of first electrodes arranged in parallel with each other; a plurality of second electrodes arranged in parallel with each other between the first electrodes; and a plurality of first electron emission regions that are electrically connected to the first electrodes.

13. The display device of claim 12, further comprising a plurality of second electron emission regions that are electrically connected to the second electrodes; and
the first and second electrodes function alternately as cathode and gate electrodes.

14. The display device of claim 12, wherein each of the electron emission elements further comprises a first connecting portion interconnecting first ends of the first electrodes, and a second connecting portion interconnecting second ends of the second electrodes;
the electron emission unit comprise a plurality of first conductive lines extending from the first connecting portions of the electron emission elements to an edge of the first substrate, and a plurality of second conductive lines extending from the second connecting portions of the electron emission elements to the edge of the first substrate.

15. The display device of claim 14, wherein the light emission device further comprises an insulation layer located between the first substrate and each of the electron emission elements while covering the first and second conductive lines;
the insulation layer is provided with via-holes for partly exposing the first and second conductive lines of each electron emission elements; and
the via-holes are filled with a conductive layer to electrically connect the first and second conductive lines to the first and second connecting portions, respectively.

16. The display device of claim 14, wherein the first conductive lines are connected to the first connecting portions that are arranged along the first direction of the first substrate;
the second conductive lines are connected to the second connecting potions that are arranged along a direction intersecting the first direction; and
the isolation layer is located between the first and second conductive lines at a region where the first and second conductive lines intersect each other.

17. The display device of claim 13, wherein the first electrodes are spaced apart from the first connecting portion and first resistive layers are located between each of the first electrodes and the first connecting portion; and
the second electrodes are spaced apart from the second connecting portion and second resistive layers are located between each of the second electrodes and the second connecting portion.

18. The display device of claim 12, wherein the display panel includes first pixels and the light emission device includes second pixels, the number of second pixels being less than the number of the first pixels and wherein the light emission intensity of each second pixel is independently controlled.

19. The display device of claim 12, wherein the display panel is a liquid crystal display panel.
